(19) United States
(12) Patent Application Publication
(10) Pub. No.: US 2011/0076655 A1
(43) Pub. Date: Mar. 31, 2011

(54) Wiring Harness Manufacturing Method and System

(75) Inventors: Marc Brosseau, Boisbriand (CA); Sylvain Desabrais, Mirabel (CA); Danielle Cauchie, St-Placide (CA); Michel Croteau, Laval (CA); Alain Pare, Boisbriand (CA)

(73) Assignee: B3CG INTERCONNECT INC., Saint-Eustache (CA)

(21) Appl. No.: 12/772,743

(22) Filed: May 3, 2010

Related U.S. Application Data
(60) Provisional application No. 61/213,051, filed on May 1, 2009.

(51) Int. Cl. G09B 19/00

(52) U.S. Cl. 434/224

(57) ABSTRACT

A method and a system for manufacturing a wiring harness is provided, the method comprising acquiring data about the wiring harness to be manufactured, the wiring harness data including data about a plurality of wires to be assembled into the wiring harness, grouping the wires based on their data, providing wire cutting instructions based on the grouping the wires, cutting wires in accordance with the cutting instructions and assembling the cut wires to for the wiring harness.

### CROSS-REFERENCE TO RELATED APPLICATION

This application claims the benefits of U.S. provisional patent application No. 61/213,051 filed on May 1, 2009, which is herein incorporated by reference.

### FIELD OF THE INVENTION

This invention relates generally to a method and system for the manufacturing of wiring harnesses.

### BACKGROUND OF THE INVENTION

Electricity is used everywhere. Electric power and electric signals are used by many of today's products. Electricity powers motors and devices while electric signals are used to sense and control various components. It is therefore common to have both an electric power system and an electric signal system in a single apparatus.

Electric power and electric signals are generally transmitted with wires from a start position to a destination position. For instance, it could be from a power source to a light, or a fan, in the case of an electric power circuit. Conversely, in the case of electric signals, a wire can be routed from a computer board to a sensor to transmit data between the sensor and the computer board.

Many wires are commonly required on a product to route electric power and electric signals between various components. It is therefore good practice to group the wires together such that they follow a single path. It helps to protect the wires, to more easily retrieve a particular wire when assembled on the apparatus, to reduce electromagnetic fields and to define the space required to allow passage of the wires. Such a group of wires is called a wiring harness.

From the main portion of the harness extends secondary branches routed to connect their associated components. The wiring harness comprises electric wires, terminals fittings attached to the ends of the electric wires and other parts such as connectors, tubes, protectors, tapes, grommets, seals and the like.

A protector can surround portions of the wiring harness. The protector is made, for example, of isolative synthetic resin, having a gutter-like cross-section. The protector is sized to accommodate electric wires therein, and tape is optionally wound around the protector to further secure the electric wires therein. The tape is preferably made of flexible non-conductive synthetic resin. An adhesive face is formed on one surface of the tape. The tape is wound directly around the group of electric wires or on the protector.

As mentioned above, the wiring harness is composed of a plurality of wires. Each wire has a unique and specific purpose and needs to be identified, cut to a proper length and installed at the right position in the wiring harness. Each wire's end refers to either a “from-position” (origin) or a “to-position” (destination). There is therefore a plurality of “from-to” positions to manage in association with the plurality of wires in the wiring harness.

Some products embed complex electronic devices and the number of wires can be significantly high. It quickly becomes complicated, confusing, tedious and therefore expensive to build wiring harnesses for such products. Moreover, products can evolve over time and in turn the complexity of the wiring harness. The risk of error is thus significant.

Therefore, a need for an improved method for manufacturing a wiring harness over the known art has been felt.

### SUMMARY OF THE INVENTION

According to one aspect of the present invention, there is provided a method for providing instructions for the manufacture of a wiring harness, comprising:
acquiring data about the wiring harness to be manufactured, the wiring harness data including data about a plurality of wires to be assembled into the wiring harness;
grouping the wires based on their data; and
providing wire cutting instructions based on the grouping of the wires.

According to a further aspect of the present invention, there is provided a method for manufacturing a wiring harness, comprising:
acquiring data about the wiring harness to be manufactured, the wiring harness data including data about a plurality of wires to be assembled into the wiring harness;
grouping the wires based on their data;
providing wire cutting instructions based on the grouping of the wires;
cutting wires in accordance with the cutting instructions; and
assembling the cut wires to form the wiring harness.

According to another aspect of the present invention, the methods are such that the wiring harness data includes connector data associated with at least some of the plurality of wires and further comprise the step of providing wire-connector assembly instructions.

According to yet another aspect of the present invention, the methods further comprise the step of optimizing the wire groupings so as to minimize setup time between changeovers in the wire cutting and wire-connector assembly instructions.

According to a further still aspect of the present invention, there is provided a system for providing instructions for the manufacture of a wiring harness, comprising:
an input for acquiring data about the wiring harness to be manufactured, the wiring harness data including data about a plurality of wires to be assembled into the wiring harness;
a processing unit operatively connected to the input, the processing unit being configured so as to group the wires based on their data; and
an output operatively connected to the processing unit, the output being adapted to provide wire cutting instructions based on the grouping of the wires.

According to a further yet aspect of the present invention, there is provided a system for manufacturing a wiring harness, comprising:
an input for acquiring data about the wiring harness to be manufactured, the wiring harness data including data about a plurality of wires to be assembled into the wiring harness;
a processing unit operatively connected to the input, the processing unit being so configured so as to:
group the wires based on their data; and
provide wire cutting instructions based on the grouping of the wires;
a cutting machine operatively connected to the processing unit for cutting wires in accordance with the cutting instructions.

According to another aspect of the present invention, the systems are such that the wiring harness data includes connector data associated with at least some of the plurality of wires and the processing unit is further configured so as to providing wire-connector assembly instructions, the second system further comprising a connector assembly machine operatively connected to the processing unit for assembling connectors onto associated wires in accordance with the connector assembly instructions.

According to yet another aspect of the present invention, the systems are such that the processing unit is further configured so as to optimize the wire groupings so as to minimize setup time between changeovers in the wire cutting and wire-connector assembly instructions.

### BRIEF DESCRIPTION OF THE DRAWINGS

Embodiments of the invention will be described by way of example only with reference to the accompanying drawings, in which:

FIG. 1 is a schematic view of an example of a computer system that may be used with an illustrative embodiment of the present invention;

FIG. 2 is an example of a table listing “from” and “to” coordinates of a plurality of wires;

FIG. 3 is an example of a table listing devices and connectors associated with a plurality of wires;

FIG. 4 is an example of a computer assisted drawing illustrating a harness with its plurality of ramifications;

FIG. 5 is a block diagram showing an example of the basic structure of a wiring harness manufacturing system in accordance with an illustrative embodiment of the present invention;

FIG. 6 is a flow diagram of a general wiring harness assembly process;

FIG. 7 is a flow diagram of process for generating wire cutting instructions and wiring grouping that can be used with the process of FIG. 6;

FIG. 8 is a flow diagram of a process for generating wire-connectors assembly instructions that can be used in conjunction with the process of FIG. 7;

FIG. 9 is a flow diagram of a wiring harness adjustment process in accordance with an illustrative embodiment of the present invention;

FIG. 10 is a flow diagram of a wiring harness manufacturing process in accordance with an illustrative embodiment of the present invention;

FIG. 11 is a block diagram of an example of a system adapted to execute the wiring manufacturing process of FIG. 10;

FIG. 12 is an example of a printout of a wiring harness table setup adapted to receive and route each wire of an exemplary wiring harness;

FIG. 13 is an example of an assembly list that can be provided by the process of FIG. 10;

FIG. 14 is an example of a bill of material that can be provided by the process of FIG. 10;

FIG. 15 is another example of a bill of material that can be provided by the process of FIG. 10;

FIG. 16 is an example of a quality control check list that can be provided by the process of FIG. 10;

FIG. 17 is an example of a wire quality control list that can be provided by the process of FIG. 10;

FIG. 18 is an example of a wire cutting form that can be provided by an illustrative embodiment of the present invention;

FIG. 19 is an example of a wiring harness test file transcript (page 1 of 5);

FIG. 20 is an example of a wiring harness test file transcript (page 2 of 5);

FIG. 21 is an example of a wiring harness test file transcript (page 3 of 5);

FIG. 22 is an example of a wiring harness test file transcript (page 4 of 5); and

FIG. 23 is an example of a wiring harness test file transcript (page 5 of 5).

### DESCRIPTION OF ILLUSTRATIVE EMBODIMENT(S) OF THE INVENTION

Generally stated, the non-limitative illustrative embodiment of the present invention provides a method and system for the manufacturing of wiring harnesses.

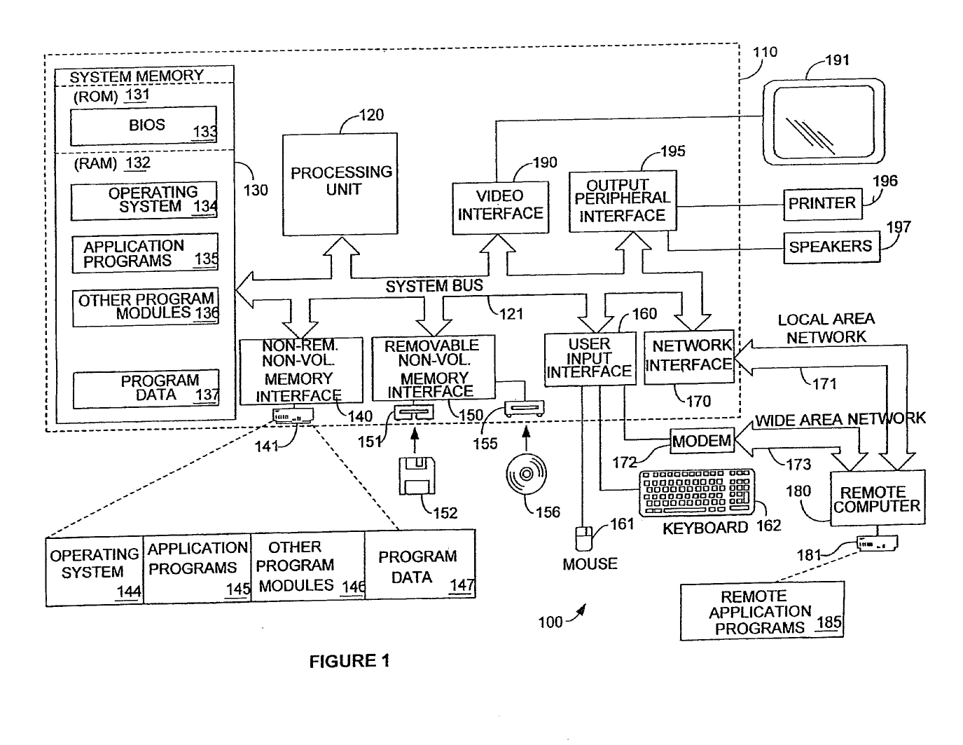

Referring to FIG. 1, there is shown an example of a computing system environment 100 usable for implementing the present invention. It is to be understood, however, that the present invention may be implemented using other general purpose or special purpose computing system environments or configurations. Examples of well known computing systems, environments, and/or configurations that may be used to implement the present invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

An example of a system for implementing the present invention includes a general-purpose computing device in the form of a computer 110. Components of the computer 110 generally include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example only, and not limitation, such architectures include Industry Standard Architecture (ISA) bus, Micro Channel Architecture (MCA) bus, Enhanced ISA (EISA) bus, Video Electronics Standards Associate (VESA) local bus, and Peripheral Component Interconnect (PCI) bus also known as Mezzanine bus.

The computing system environment 100 comprises a computer 110 typically including a variety of computer readable media. Computer readable media can be any available media that can be accessed by computer 110 and includes both volatile and nonvolatile media, removable and non-removable media. For example, computer readable media may include computer storage media and communication media.

Computer storage media includes volatile and nonvolatile, removable and non-removable media implemented in any method or technology for storage of information such as computer readable instructions, data structures, program modules or other data. Computer storage media includes, for example, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110.

Communication media typically embodies computer readable instructions, data structures, program modules or other data in a modulated data signal such as a carrier wave or other transport mechanism and includes any information delivery media. The term “modulated data signal” means a signal that has one or more of its characteristics (such as, for example, voltage or current level, voltage or current pulse existence or nonexistence, voltage or current pulse width, voltage or current pulse spacing, etc.) set or changed in such a manner as to encode information in the signal. For example, communication media may include wired media such as a wired network or direct-wired connection, and wireless media such as acoustic, RF, infrared and other wireless media. Combinations of any of the above are also included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. For example, FIG. 1 illustrates RAM 132 as containing operating system 134, application programs 135, other program modules 136, and program data 137.

The computer 110 may also include other removable/non-removable, volatile/nonvolatile computer storage media. For example, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a keyboard 162, pointing device 161 (commonly referred to as a mouse), and trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 operates in a networked environment using logical connections to one or more remote computers, such as a remote computer 180. The remote computer 180 may be a personal computer, a router, a network PC, a peer device or other common network node, and in any case the remote computer or computers typically include many or all of the elements described above relative to the personal computer 110, although only a memory storage device 181 has been illustrated in FIG. 1. The logical connections depicted in FIG. 1 include a local area network (LAN) 171 and a wide area network (WAN) 173, but the computer 110 may additionally or alternatively use one or more other networking environments. Networking environments of all types are commonplace in offices, enterprise-wide computer networks, intranets and the Internet, for example Ethernet (broadband, high-speed), wireless WiFi, cable Internet, satellite connection, etc.

The computer 110 includes facilities for accessing the networks to which it is attachable. For example, when used in a LAN networking environment, the personal computer 110 is connected to the LAN 171 through a network interface or adapter 170. Another node on the LAN, such as a proxy server, may be further connected to a WAN such as the Internet. When used in a WAN networking environment, the computer 110 typically includes a modem 172 or other means for establishing communications directly or indirectly over the WAN 173, such as the Internet. The modem 172, which may be internal or external, may be connected to the system bus 121 via the user input interface 160, or other appropriate mechanism. In a networked environment, program modules depicted relative to the personal computer 110, or portions thereof, may be stored in the remote memory storage device. For example, FIG. 1 illustrates remote application programs 185 as residing on memory device 181. It will be appreciated that the network connections shown are exemplary and other means of establishing a communications link between the computers may be used. It is not intended to limit the invention to use in a hard-wired network environment, since it may also be used in transiently connected environments, such as, for example, a wholly or partially wireless network environment interconnected wholly or partially via optical, infrared, and/or radio frequency wireless connections.

Herein, the invention is described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that variance of the acts and operation described hereinafter may also be implemented in hardware.

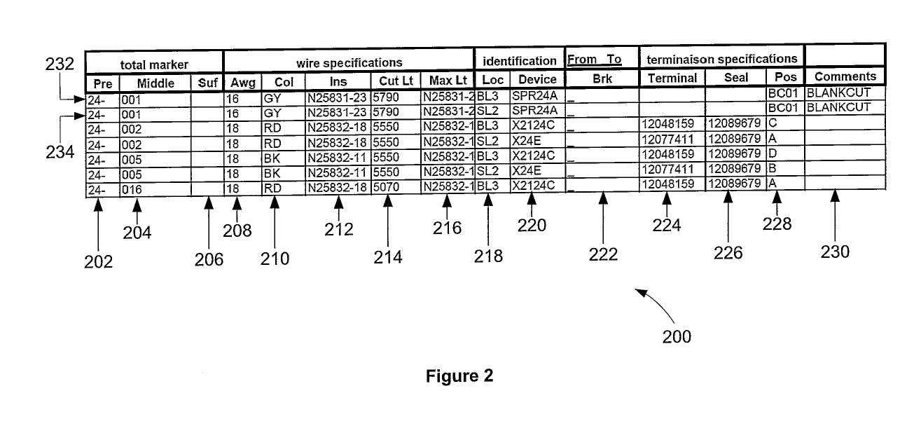

Referring now to FIG. 2, there is shown a table illustrating an example of a “From-To” list 200 of wires. The “From-To” list 200 is a table listing each wire to be included in a wiring harness. The term “From” relates to an end of the wire, while the term “To” refers to the opposite end of the same wire. Normally the “From” end is the end from which the current or the data is originating. Conversely, the “To” end is the end to which the current or the data is received. Additional information related to each wire is also included in the list 200 and will be explained later in more details.

Each wire is identified on two rows in the From-To list 200. One row is related to each end of the wire. In other words, a row relates to the “From” end and the next row relates to the “To” end of the same wire. For example, the first two rows 232, 234 of the table 200 provide information about a single wire. As mentioned above, upper row 232 relates to a “From” end of the wire and lower row 234 relates to a “To” end of the wire. Each other following wire are similarly identified in the following rows of the table 200.

The From-To list 200 includes a series of columns 202-230. Each of the columns 202-230 is dedicated to a specific type of information about the subject wire. The information is associated with the columns as follows:
the column in the From-To list 200 identified with reference number 202 relates to a numeral identification of the harness to which the wire belongs to;
the column in the From-To list 200 identified with reference number 204 relates to a wire number;
the column in the From-To list 200 identified with reference number 206 can be used for identifying possible changes to the connector on the subject end of the wire;
the column in the From-To list 200 identified with reference number 208 relates to the gage of the wire (the size of the wire);
the column in the From-To list 200 identified with reference number 210 relates to the exterior color of the wire;
the column in the From-To list 200 identified with reference number 212 relates to the type of wire;
the column in the From-To list 200 identified with numeral reference 214 relates to the length of the wire;
the column in the From-To list 200 identified with reference number 216 relates to optional data related to the wire;
the column in the From-To list 200 identified with reference number 218 relates to physical sections of the product on which the harness will be installed;
the column in the From-To list 200 identified with numeral reference 220 relates to the virtual address of the end of the wire;
the column in the From-To list 200 identified with reference number 222 relates to a break point on the main section of the harness at which the wire exits out of the main section of the harness to reach a specific element;
the column in the From-To list 200 identified with reference number 224 relates to an identification of the connector that will be connected on the subject end of the wire;
the column in the From-To list 200 identified with reference number 226 relates to an identification of the seal that seals the wire to the connector—if needed;
the column in the From-To list 200 identified with reference number 228 relates to an identification of a position on a multi-position connector; and
the column in the From-To list 200 identified with reference number 230 is left for additional comments in relation with the wire.

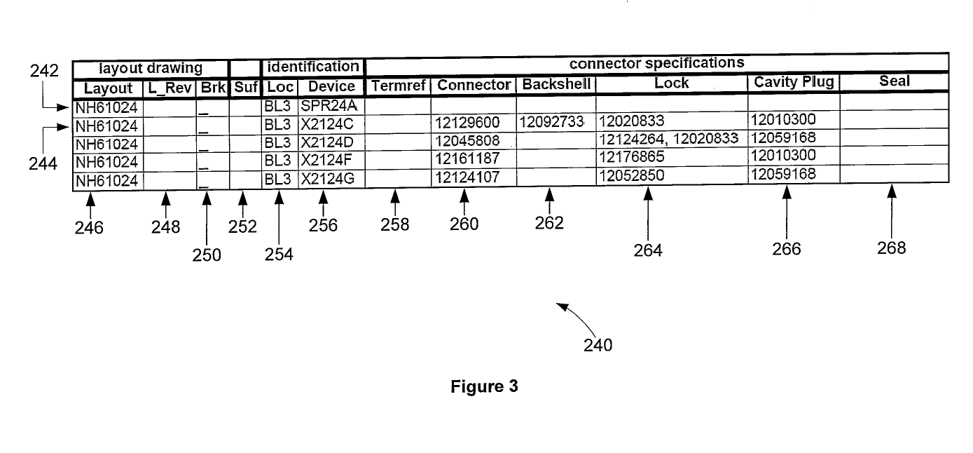

FIG. 3 shows a table illustrating an example of a “Break-Out” list 240. A “Break-Out” list actually lists material associated with each wire in the harness. As mentioned above, the information provided in the Break-Out list 240 and the From-To list 200 can alternatively be combined in a single list. The From-To list 200 and the Break-Out list 240 in the realm of the present invention will be presented as separated lists without intending to limit the scope of the present invention.

The Break-Out list 240 is a table that includes data about connectors associated with each virtual address 256 (that corresponds to the column associated with reference number 220 of FIG. 2) associated with each end of each wire. Each virtual address 256 uses one row in the Break-Out list 240. For example, the first row identified with reference number 242 of the Break-Out list 240 identified by reference number 240 provides detailed information about virtual address SPR24A. In contrast, row 244 provides detailed information related to virtual address X2124C. Each virtual address is similarly identified in the following rows of the table in the column identified by reference number 240.

The Break-Out list 240 also includes a series of columns 246-268. Each of these columns 246-268 is dedicated to additional specific information about the connection at a predetermined virtual address 256 listed in the column identified by reference number 244. The following information is associated with the various columns of the Break-Out list 240:
the column in the Break-Out list 240 identified with reference number 246 relates to a drawing number related to the harness;
the column in the Break-Out list 240 identified with reference number 248 relates to a possible revision number of the drawing of column 246;
the column in the Break-Out list 240 identified with reference number 250 relates to a break point on the main section of the harness at which the wire exits the main section of the harness to reach a specific element;
the column in the Break-Out list 240 identified with reference number 252 relates to a reference to an old system of correspondence;
the column in the Break-Out list 240 identified with reference number 254 relates to physical sections of the apparatus, or the product, to which the harness will be installed;
the column in the Break-Out list 240 identified with reference number 256 relates to the virtual address of the end of the wire, as mentioned above, this virtual address refers to the virtual address found on column identified with reference number 220 in FIG. 2;
the column in the Break-Out list 240 identified with reference number 258 related to client reference identification;
the column in the Break-Out list 240 identified with reference number 260 relates to an identification of the connector that will be connected at the virtual address identified with reference number 256;
the column in the Break-Out list 240 identified with reference number 262 relates to an identification of an additional part associated to the connector—if needed;
the column in the Break-Out list 240 identified with reference number 264 relates to an identification of an additional part associated to the connector—if needed;
the column in the Break-Out list 240 identified with reference number 266 relates to an identification of an additional plug to close unused connection point in a connector—if needed; and
the column in the Break-Out list 240 identified with reference number 268 relates to an identification of a seal adapted to seal two connectors portions there together—if needed.

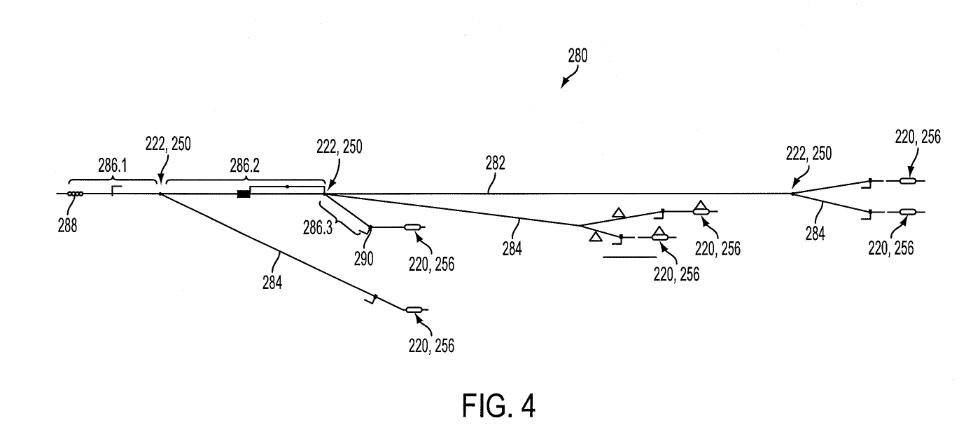

An example of a computer assisted drawing of a harness layout 280 is provided in FIG. 4. The harness layout 280 is a full scale drawing (1:1 ratio) of the wiring harness. It has to be noted that the pattern of the harness, as depicted in FIG. 4, does not represent the exact shape of the assembled wiring harness when the wiring harness is assembled with the final apparatus, but rather a schematic illustration, at scale, of the length of the wiring harness 280 and its associated harness branches.

The harness layout 280 defines a main body 282 and several break points 222, 250 leading to harness branches 284. Each harness branch 284 begins 288 and ends 220, 256 at a “virtual address”. Each virtual address is a virtual location intended to help locate components of the wiring harness. It can be appreciated that the length of each harness section 286 is defined on the drawing 280 and that the length of each wire in the harness 280 can be calculated by summarizing the length of each applicable harness section 286. For example, the length of the wire starting at point 288 and ending at point 290 is the added lengths of the three harness sections 286.1, 286.2, 286.3. The calculation of the length of each wire in the wiring harness from the computer assisted drawing is performed automatically by the system.

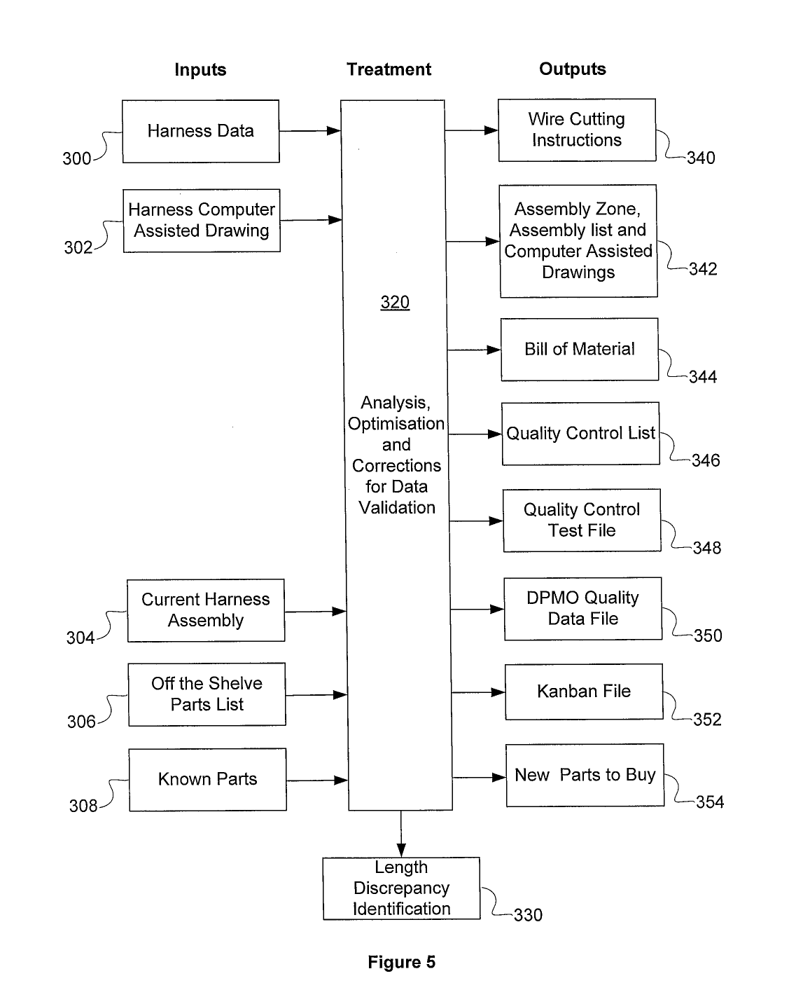

Referring now to FIG. 5, there is shown a block diagram of an example of a basic structure of a wiring harness manufacturing system including various inputs 300-308, a treatment component 320 and various outputs 330-354 in accordance with an illustrative embodiment of the present invention. Additional possible inputs include the data related to each wire in the harness 300, the harness computer assisted drawing 302, data about the harness already manufactured 304, parts that are known by the wiring harness manufacturer and already available off the shelves 306, and other known parts 308 that are easy to retrieve and be reordered by the buying department.

The treatment component 320 is adapted to manipulate the inputted data and process the data in order to produce the desired outputs. The treatment component 320 may be, for example, a computerized system adapted to carry on various mathematical and logical functions. Mathematical and logical functions are used in conjunction with the method to manipulate the inputted data.

There are several possible outputs produced by the treatment component 320. Firstly, possible discrepancies among inputted data are identified 330 such that they can be corrected before the treatment component 320 provides other outputs. The user is prompted if discrepancies are found and an action is required from the user to waive the message by correcting or acknowledging each discrepancy.

Once there are no more data discrepancies, the treatment component 320 provides a number of elements forming the manufacturing plan of the wiring harness. Among these elements are wire cutting instructions 340 for each wire to be assembled in the harness, computer assisted drawings identifying assembly zones and associated assembly lists 342, which are provided to physically manufacture the harness. There are also provided a bill of material 344, a quality control list 346, a quality control test file 348, a DPMO quality data file 350, a Kanban file and a list of new parts to buy 354.

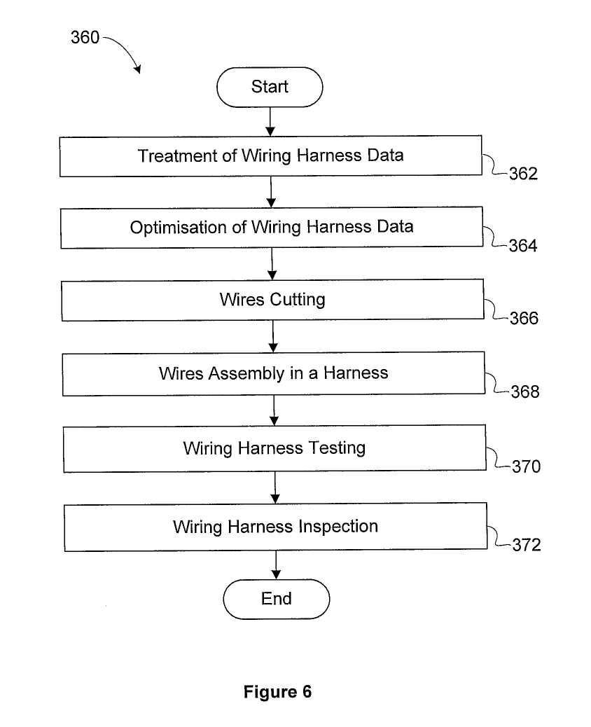

Turning now to FIG. 6 through FIG. 11, there are shown some examples of processes in accordance with various illustrative embodiments of the present invention.

Firstly, FIG. 6 shows a flow diagram of a high level process 360 starting, at block 362, with the treatment of the wiring harness data that has been described above in respect with FIG. 2 through FIG. 4.

At block 364, once the treatment of the data is done, an optimization of the wiring harness data is performed.

Then, at block 366, the wires are cut at their respective specifications and, at block 368, assembled to form the wiring harness.

At block 370, the manufactured wiring harness is tested and, at block 372, inspected.

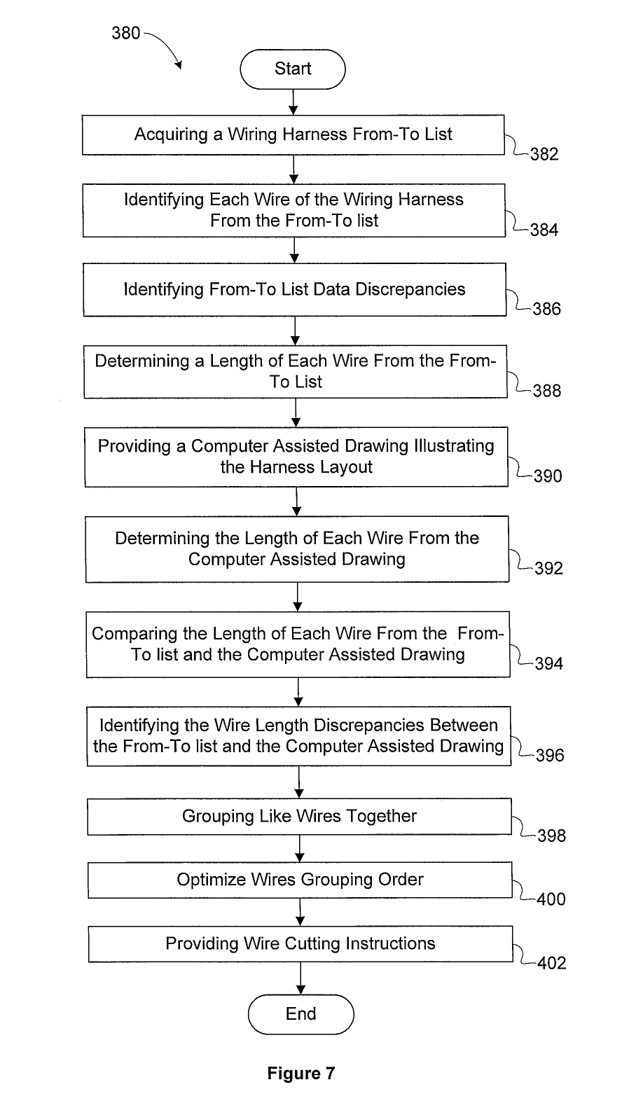

Referring now to FIG. 7, there is shown a flow diagram of a process 380 for generating wire cutting instructions and grouping wires, which starts, at block 382, by acquiring a wiring harness From-To list 382.

Then, at block 384, each individual wire listed in the From-To list is identified and, at block 386, possible discrepancies among the inputted data are evaluated so that corrupted data can be identified to prevent any further use of corrupted data in the process.

After the length of each wire listed in the From-To list is determined, block 388, a computer assisted drawing file is provided at block 390. The computer assisted drawing file may be, for example, an AutoCAD™ (.DWG) file.

Next, at block 392, the length of each wire is calculated from the computer assisted drawing file and, at block 394, is compared to the length of the corresponding wire from the From-To list wire.

Then, at block 396, any discrepancies between the corresponding lengths of each wire is identified and corrected, when necessary, and like wires are grouped together to batch process some steps like wire cutting or assembling like connectors.

At block 400, an optimizer using a sorting algorithm and a machine setup penalty calculator calculates the most efficient way to sequence the wire groupings for production. The optimizer evaluates the machine setup times required to change from one wire grouping to another and sequences the wire cutting instructions so that the setup time between changeovers is minimal, therefore lowering production times and improving production capacity.

In an illustrative example of the optimizer, six criteria are used to group the wires. Each criterion is associated with an assembling penalty value representing lost time during the changing of a given machine setup to another. The criteria are listed in a decreasing value order, i.e. the first criterion having the highest penalty value and the sixth criterion the lowest.

The six criteria are as follows:
the first and second criteria are related to the presence of first and second sealants, respectively;
the third and fourth criteria are related to the presence of first and second connection terminals, respectively; and
the fifth and sixth criteria are related to the type of wire and its length, respectively.

Accordingly, the length of a wire has little impact (criterion 6) compared to the presence of sealants (criteria one and two) which involve the changing of sealants on the machine.

Wires are then separated into three groups, a first group with wires having two sealants, a second group with wires having one sealant and a third group with wires not having sealants.

For each group, wires having identical first five criteria are separated in sub-groups. Criterion six, related to the length of the wires, is used to sort the wires within each sub-group in a decreasing order.

The optimizer then orders the various sub-groups of each group by combining as many criteria as possible, starting from the ones having the highest penalty values and ending with the ones with the lowest penalty values.

The purpose of the optimizer is to determine the order of assembly of the wires having the lowest assembling penalty, which results in an optimized setup time.

Finally, at block 402, wire cutting instructions are provided.

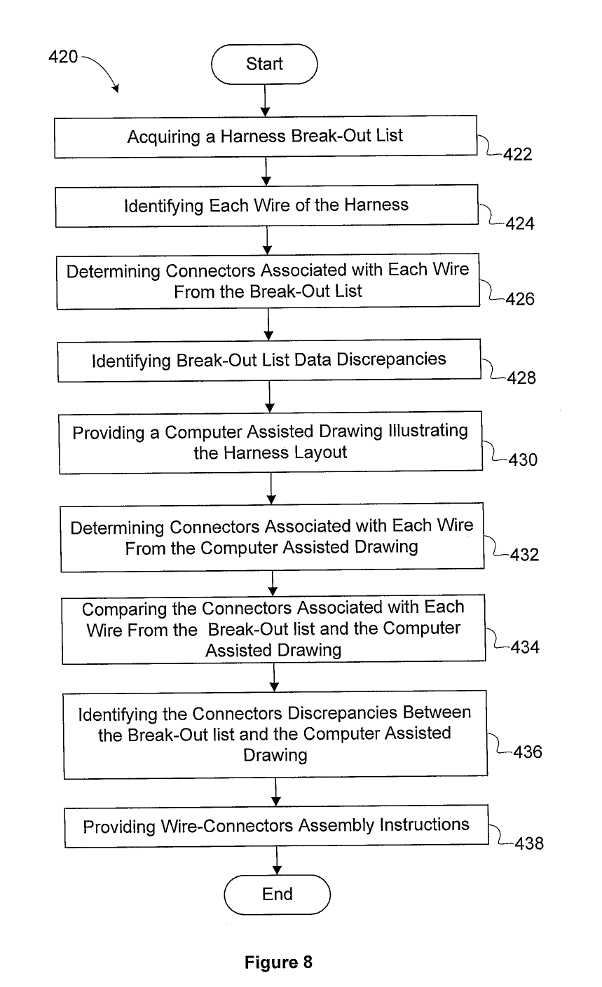

Turning now to FIG. 8, there is shown a flow diagram of process 420 for generating wire-connectors assembly instructions, which starts, at block 422, by acquiring a harness Break-Out list containing additional information related to each wire and, at block 424, identify each wire of the harness.

Connectors associated with each wire are then determined, at block 426, and possible discrepancies among the connector data are evaluated at block 428.

Then, at block 430, a computer assisted drawing file of the wiring harness is provided and connectors associated with each wire are determined, at block 432, from the computer assisted drawing file.

Next, at block 434, connector data of each wire is determined from the computer assisted drawing file and compared to the connector data of the corresponding wire from the Break-Out list.

Then, at block 436, any discrepancies between the corresponding connector data of each wire is identified and corrected, when necessary.

Finally, at block 438, wire-connectors assembly instructions are provided.

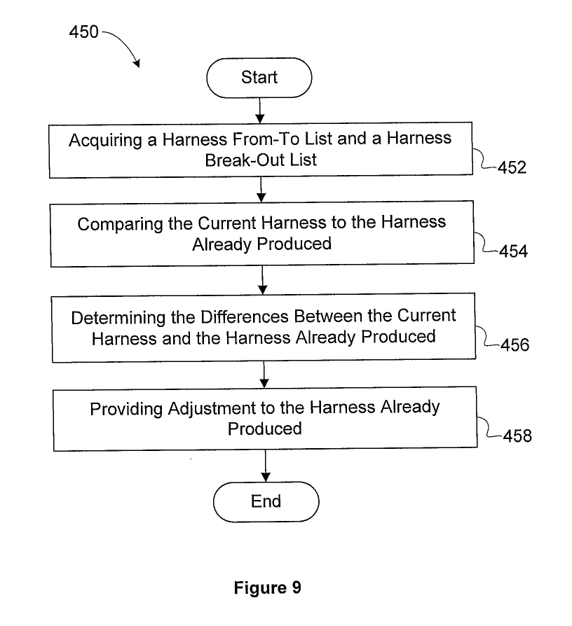

Referring to FIG. 9, there is shown a flow diagram of a wiring harness adjustment process 450 in accordance with an illustrative embodiment of the present invention.

The process 450 starts at block 452 by acquiring a wiring harness From-To list and a wiring harness Break-Out list.

Then, at block 454, parts of the current harness are compared to the parts on record from an already existing wiring harnesses that have already been manufactured to determine, at block 456, the differences among the parts and provide, at block 458, adjustment to the wiring harness already produced to avoid creating a completely new wiring harness when minor modifications can be performed on an already existing wiring harness.

Process 450 thus represents a time saving feature in cases of constantly evolving wiring harnesses to figure out differences between already existing wiring harnesses and the instant wiring harness to be manufactured.

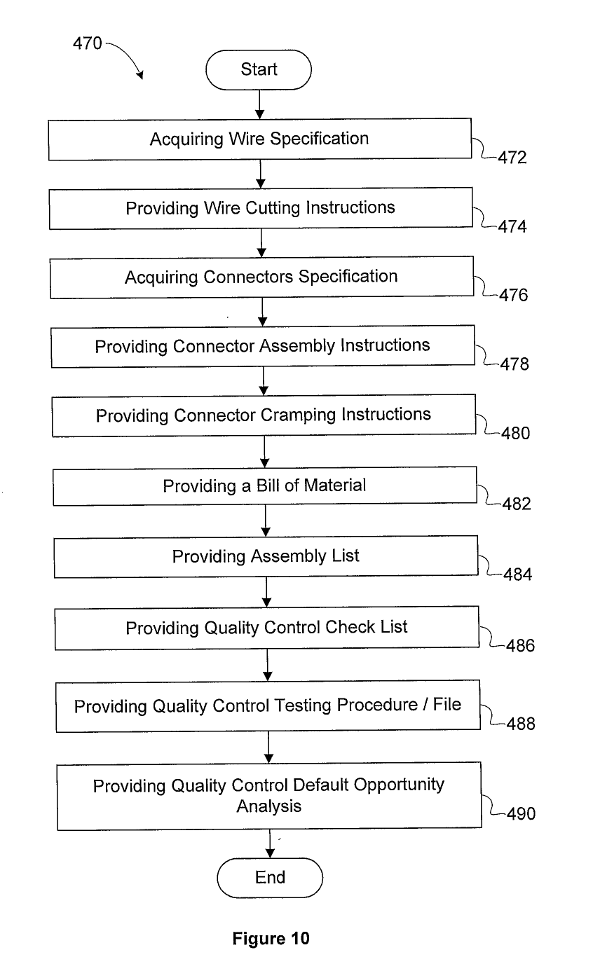

Referring now to FIG. 10, there is shown a flow diagram of a wiring harness manufacturing process 470 in accordance with an illustrative embodiment of the present invention.

The process 470 starts at block 472 by acquiring wire specifications and then executing a process for generating wire cutting instructions and grouping wires, such as process 380 of FIG. 7, followed by, at block 474, providing cutting instructions for each wire.

Then, at block 476, connector specifications are acquired and a process for generating wire-connectors assembly instructions, such as process 420 of FIG. 8, is executed, following which, at block 478, wire-connector assembly instructions are provided for each wire.

Next, at block 480, connector crimping instructions are provided.

The process 470 further provides the following:
at block 482, a bill of material of the material required to manufacture the wiring harness;
at block 484, a wiring harness assembly list;
at block 486, a quality control check list to ensure the wires' routing and the connectors installation are proper;
at block 488, a quality control testing procedure or file for evaluating if the final routing of each wire in the harness is equivalent to the routing indicated in the harness' data; and
at block 490, a quality control default opportunity analysis which considers the number of wires and the number of possible connections in each connector.

The quality control default opportunity analysis gathers all the possible causes of defects found in each step of the manufacturing process of a wiring harness. For example, possible causes of defects related to the wire may be as follows: type of wire=1 defect opportunity; gage AWG of wire=1 defect opportunity; color of the wire=1 defect opportunity; length of cut wire=1 defect opportunity; length of stripped portion on the wire=2 defect opportunities; and choice of terminal on the wire=1 defect opportunity. Other defect opportunities related to the wire assembly may be as follows: choice of connector=1 defect opportunity; type of wire=1 defect opportunity; proper mechanical securing of each wire with the connector=1 defect opportunity; and risk of inserting the wire in the wrong connector having four positions=7 defect opportunities.

The defect per opportunity (DPO) is calculated at the end of the cycle using the following equation:

DPO=#defects/(#units×#DOC) Equation 1

where
#defects is the number of defects;
#units is the number of units; and
#DOC is the number of defect opportunities on the connector.

Finally: Defect Per Million Opportunities (DPMO)=DPO×10⁶.

It is to be understood that in alternative embodiments any or all of the various lists, procedure/file, analysis and bill of process 470 may be optional.

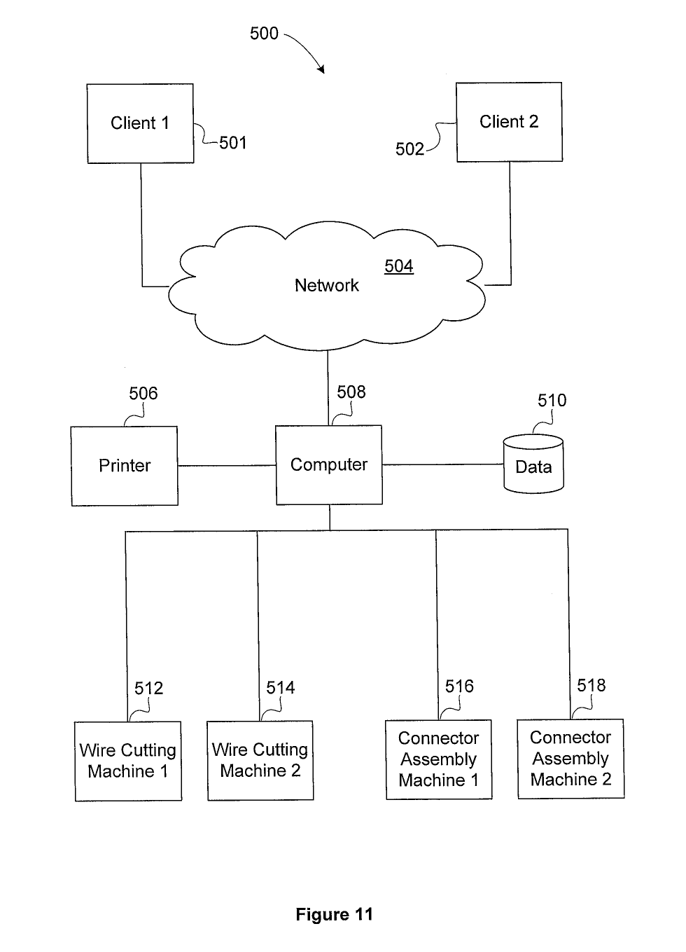

Turning to FIG. 11, there is shown a block diagram of an example of a system 500 adapted to execute the wiring manufacturing process of FIG. 10. The system 500 is illustrated with two clients 501, 502 that are in communication with the computer 508 carrying configured to execute, in part or in whole, process 470 of FIG. 10, through a network 504 using, for example a VPN, or other communication means. Clients 501, 502 provide data about the wiring harness to the computer 508 which stores the data in a database 510 and has access to a printer 506 in order to, for example, print wiring diagrams, discrepancies reports, various assembly lists, quality control default opportunity analysis, etc. The computer 508 is also in connection with, in the present illustrative example, two wire cutting machines 512, 514 and two connector assembly machines 516, 518. Both the cutting machines 512, 514 and the connector assembly machines 516, 518 are provided with automation capabilities using numerical controllers. Cutting instructions can be communicated from the computer 508 directly to the wire cutting machines 512, 514. Similarly, wire-connector assembly instructions can be communicated from the computer 508 to the connector assembly machines 516, 518.

It is to be understood that other system configurations are possible and that the number of clients, wire cutting machines and connector assembly machines may vary, and that further equipment may be added.

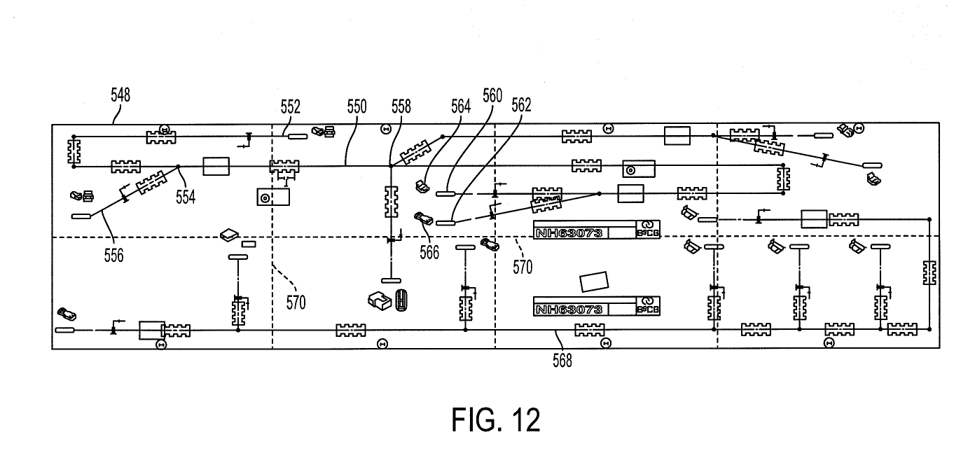

Referring now to FIG. 12, there is shown a printout of a wiring harness table setup adapted to receive and route each wire of an exemplary wiring harness. The printout, which is a full scale (1:1 ratio) printout, is adapted to fit on the mounting table 548 and presents a first wiring harness 550 thereon. The harness 550 has a first end 552 that leads to a first junction 554 from which extends a harness branch 556. A second junction point 558 from which extends three additional branches is also present on the wiring harness 550 drawing. The wiring harness 550 ends with two harness ends 560, 562. The connector to be mounted on each end of a wire is indicated close-by on the printout. For example, ends 560, 562 are illustrated nearby with their respective connectors 564, 566. It can be appreciated that another wiring harness 568 is disposed next to the wiring harness 550 to maximize the space on the mounting table 548. It can also be appreciated that the mounting table 548 is separated in sections discriminated by lines 570. The sections are used to easily retrieve a wire or a connector on the mounting table. The sections are also associated with a portion of the product to which the manufactured wiring harness is to be mounted to provide easy correlation between the mounting table 548 and the actual product.

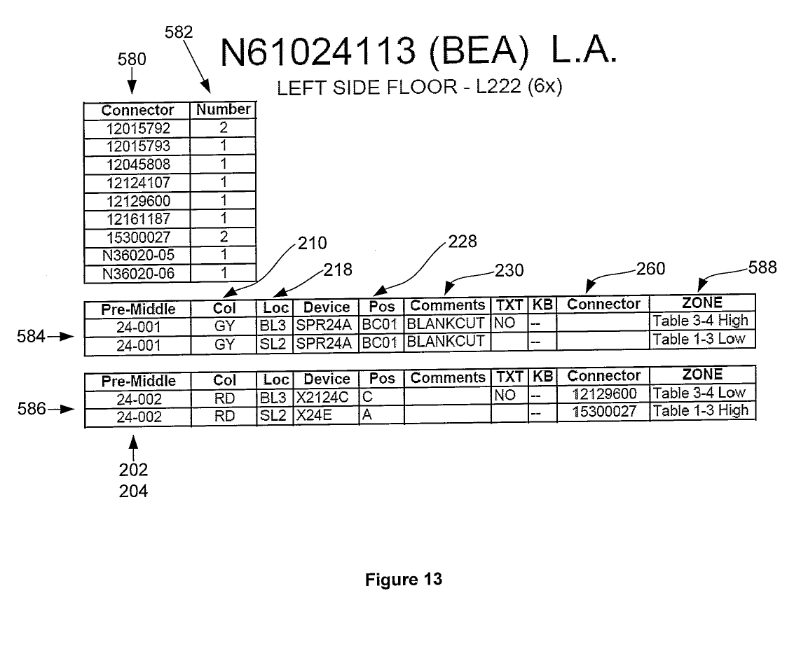

Turning now to FIG. 13, there is shown an example of an assembly list which may be provided at block 484 of process 470 (see FIG. 10). The assembly list provides a list of connectors 580 and the quantity of each connector 582. Then, each end of each wire 584 is listed with a number of related information such as the color of the wire 210. The column identified by reference number 218 refers to the physical section of the product on which the harness will be installed. The column identified with reference number 228 relates to an identification of a position on a multi-position connector; and the column identified with reference number 230 is left for additional comments in relation with the wire. The column identified with reference number 260 relates to an identification of the connector to be installed on the end of the wire, if applicable, and column identified with reference number 588 indicates the position of each end of the wire on the mounting table 548 (see FIG. 12) to ease retrieval of the wire. The same information is provided for each wire, wire 586 being a further example.

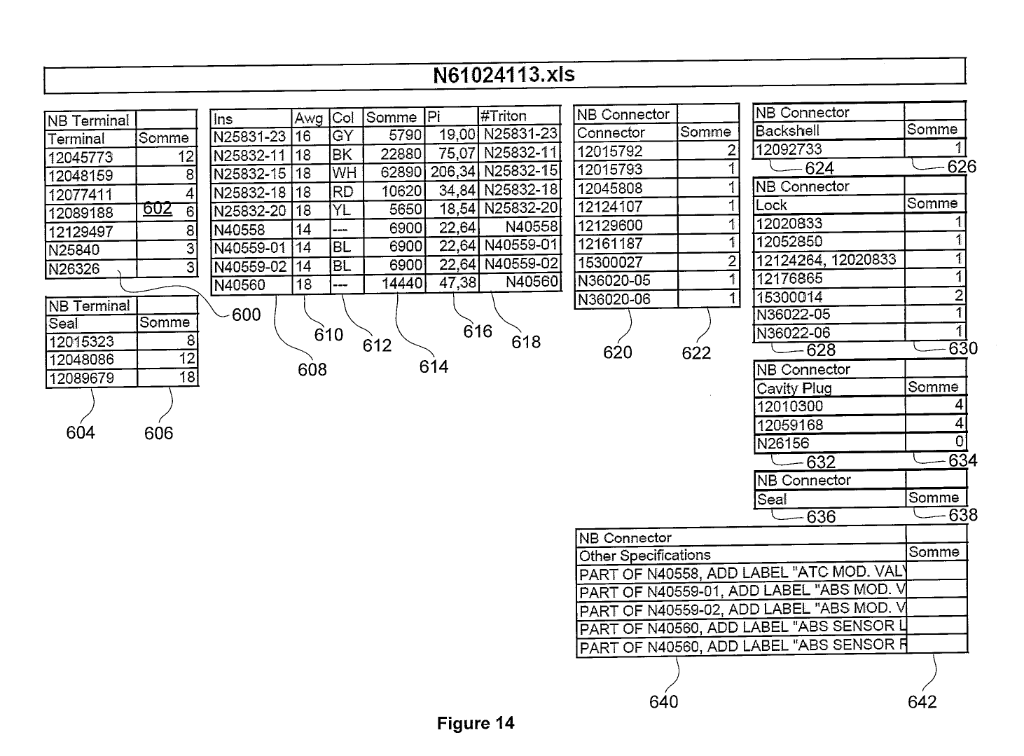

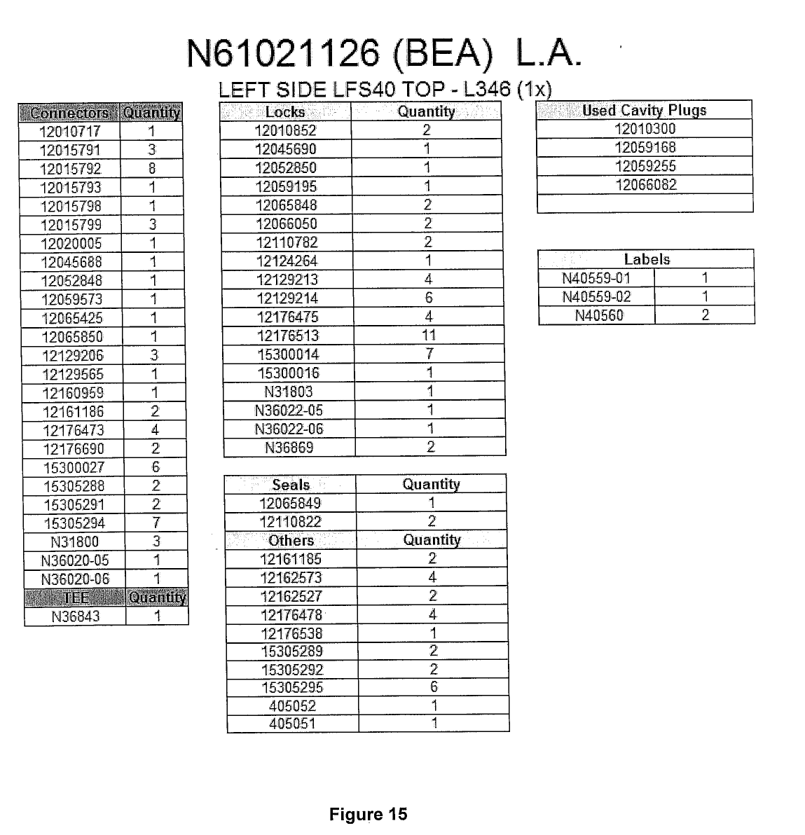

Referring to FIG. 14, there is shown an example of a bill of material which may be provided at block 482 of process 470 (see FIG. 10). In summary, there is a listing of terminals 600 and their associated quantities 602, the terminal seals 604 and their associated quantities 606, wire identifications 608, wire gages 608, wire colors 612, total length of the wires in millimeters 614, total length of the wires in inches 616, internal reference numbers 618, a listing of connectors 620 adapted to mate the terminals 600 with their associated quantities 622, a listing of connector back shells 624 and their associated quantities 626, a listing of connector locks 628 and their associated quantities 630, a listing of connector cavity plugs 632 and their associated quantities 634 and a listing of connector seals 636 and their associated quantities 638. Other specifications are provided 640, 642 as needed. An alternative bill of material is shown in FIG. 15. The information included therein is substantially similar to the information provided in the bill of material of FIG. 14 and will not be discussed in further details.

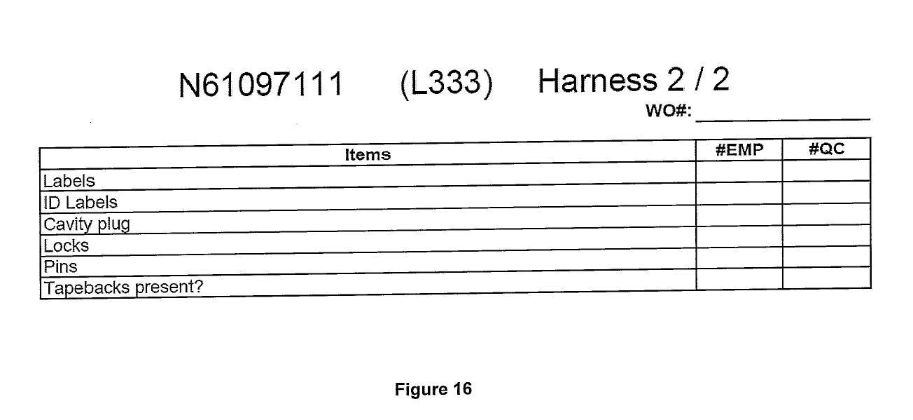

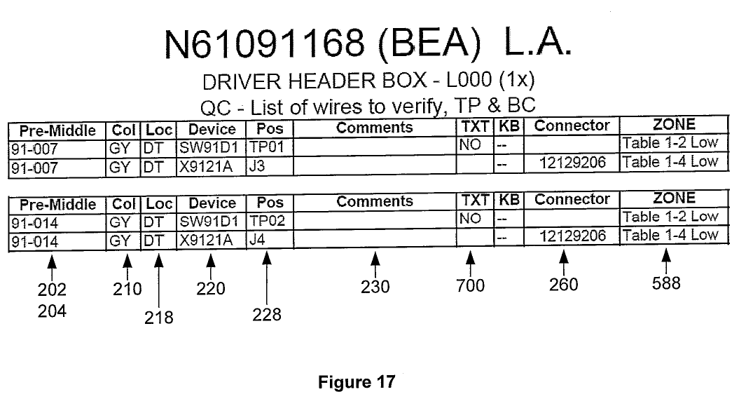

Referring to FIG. 16 and FIG. 17, there are shown examples of a quality control checklist and a quality control list of wires, respectively, which may be provided at block 486 of process 470 (see FIG. 10). Each column of FIG. 17 has been previously discussed above except for column 700 which refers to optional text to be written on the wire.

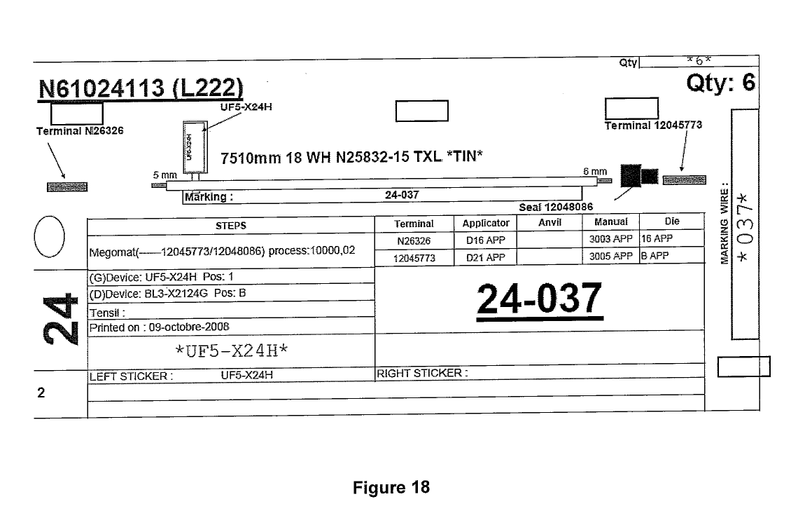

Referring now to FIG. 18, there is shown an example of a wire cutting form providing a number of information required or helpful at the time of cutting a wire.

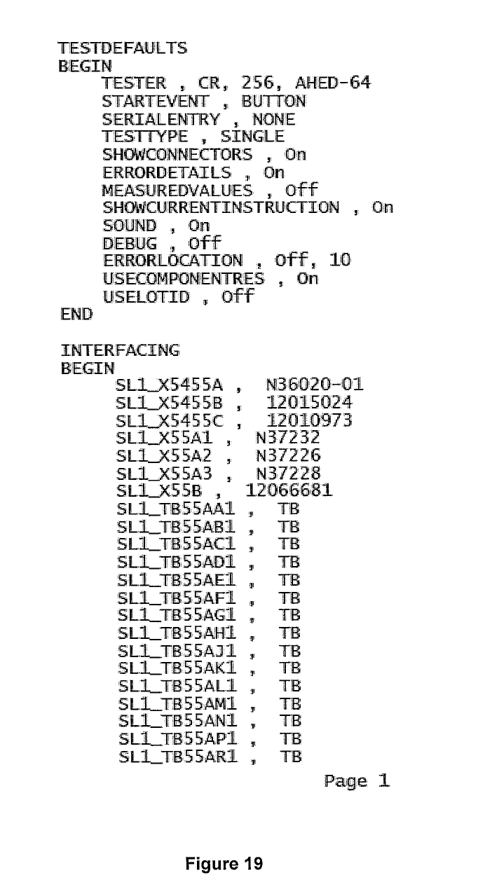

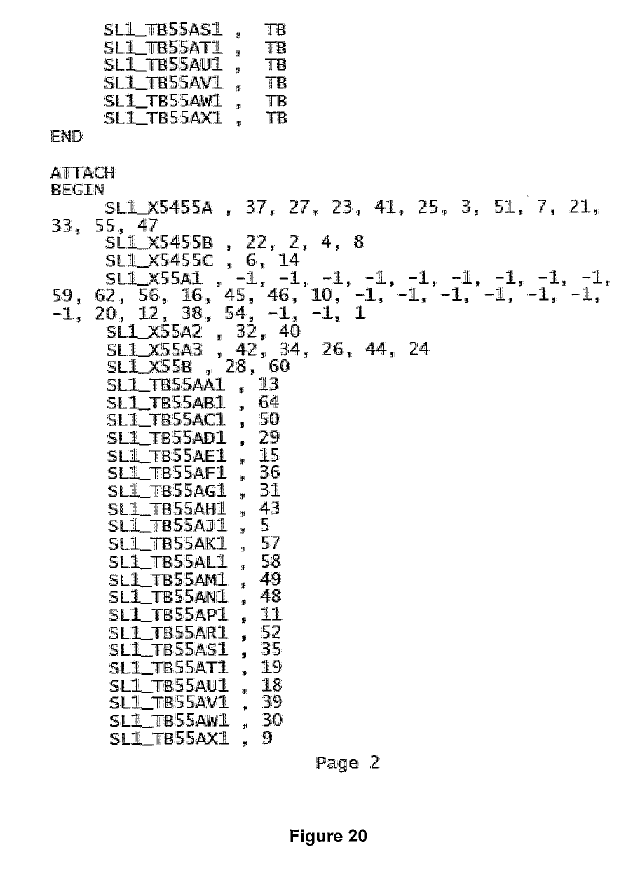

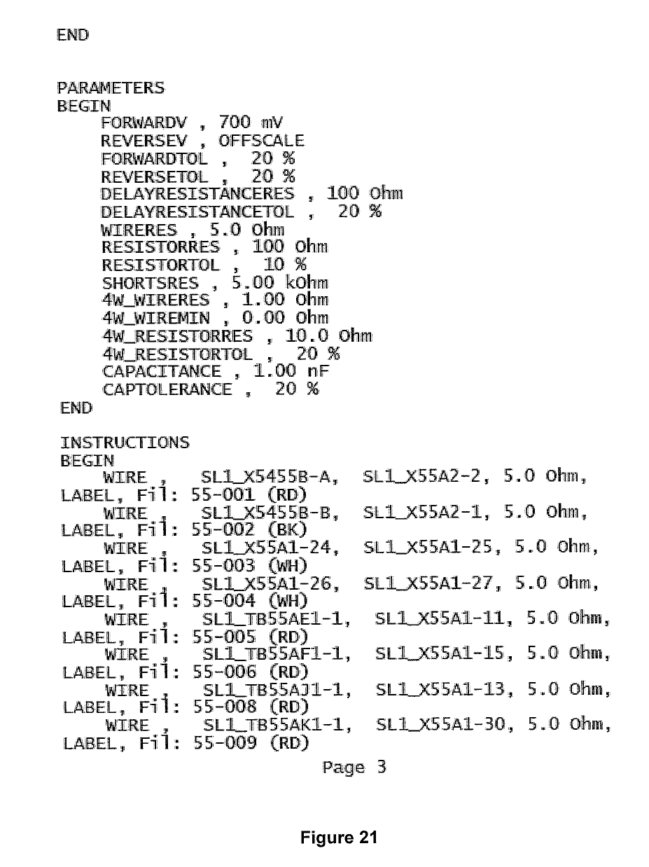

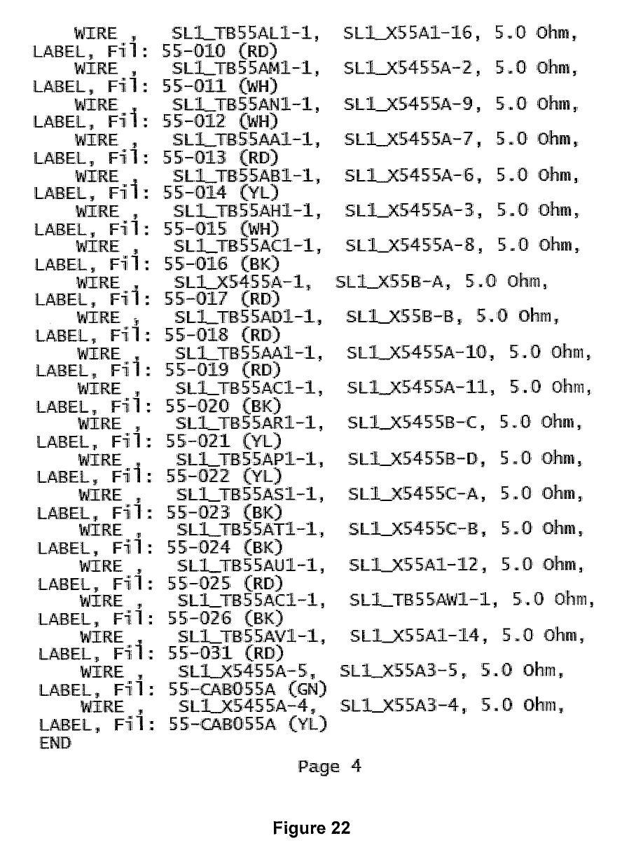

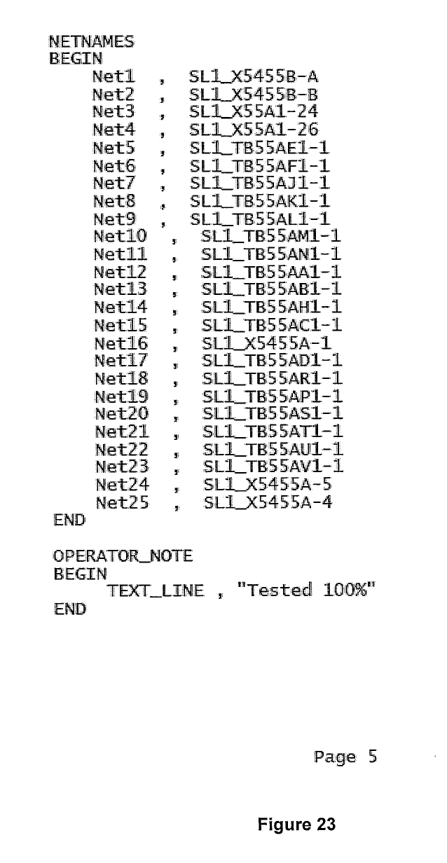

Finally, referring to FIG. 19 through FIG. 23, there is shown an example of a quality control test file, which may be provided at block 488 of process 470 (see FIG. 10), for testing the assembled wiring harness to ensure each wire is properly routed in the wiring harness.

Although the present invention has been described by way of particular embodiments and examples thereof, it should be noted that it will be apparent to persons skilled in the art that modifications may be applied to the present particular embodiment without departing from the scope of the present invention.

What is claimed is:

1. A method for providing instructions for the manufacture of a wiring harness, comprising:
acquiring data about the wiring harness to be manufactured, the wiring harness data including data about a plurality of wires to be assembled into the wiring harness;
grouping the wires based on their data; and
providing wire cutting instructions based on the grouping of the wires.

2. The method of claim 1, wherein the wiring data includes for each wire at least one of the wire number, a gage of the wire, an exterior color of the wire, a type of the wire, a length of the wire, a virtual address of the end of the wire, a break point at which the wire exists out of the wiring harness, a connector to be connected to the end of the wire, an identification of a seal that seals the wire to a connector and a position identification on a multi-position connector.

3. The method of claim 1, wherein the wiring harness data includes connector data associated with at least some of the plurality of wires and further comprising the step of providing wire-connector assembly instructions.

4. The method of claim 3, wherein the wiring data includes for each wire at least one of a connector identification, a connector additional part identification, a connector additional plug identification and a connector seal identification.

5. The method of claim 3, further comprising the step of optimizing the wire groupings so as to minimize setup time between changeovers in the wire cutting and wire-connector assembly instructions.

6. The method of claim 5, wherein the optimization of the wire groupings is based on criteria associated with an assembling penalty value.

7. The method of claim 6, wherein the penalty value represents lost time during the changing of a given machine setup to another during the manufacture of the wiring harness.

8. The method of claim 6, wherein the criteria include:
a first and second criteria related to the presence of a first and a second sealant;
a third and fourth criteria related to the presence of first and second connection terminals; and
a fifth and sixth criteria related to the type of wire and the length of wire.

9. The method of claim 8, wherein the first to sixth criteria have decreasing respective penalty values.

10. The method of claim 3, further comprising providing at least one of a bill of material, an assembly list, a quality control check list, a quality control test procedure and a quality control default opportunity analysis.

11. The method of claim 1, further comprising the step of providing a wiring harness assembly drawing illustrating the wiring harness layout.

12. The method of claim 11, wherein the drawing is full-scale.

13. The method of claim 1, wherein the wiring data includes respective first lengths of the plurality of wires, the method further comprising:
providing a drawing of the wiring harness layout;
inferring respective second lengths of the plurality of wires from the drawing;
comparing the respective first lengths and the respective second lengths of the wires; and
identifying a wire length discrepancy between the respective first lengths and the respective second lengths of the wires.

14. The method of claim 13, further comprising providing a corrected wire length when a wire length discrepancy has been identified.

15. The method of claim 1, further comprising the steps of:
comparing the acquired wiring harness data with existing wiring harness data; and
identifying a corresponding existing wiring harness;
wherein the step of grouping the wires is further based on the wire grouping of the identified corresponding existing wiring harness.

16. A method for manufacturing a wiring harness, comprising:
acquiring data about the wiring harness to be manufactured, the wiring harness data including data about a plurality of wires to be assembled into the wiring harness;
grouping the wires based on their data;
providing wire cutting instructions based on the grouping of the wires;
cutting wires in accordance with the cutting instructions; and
assembling the cut wires to form the wiring harness.

17. The method of claim 16, wherein the cutting instructions contain instructions executable by an automated cutting machine.

18. The method of claim 16, wherein the wiring data includes for each wire at least one of the wire number, a gage of the wire, an exterior color of the wire, a type of the wire, a length of the wire, a virtual address of the end of the wire, a break point at which the wire exists out of the wiring harness, a connector to be connected to the end of the wire, an identification of a seal that seals the wire to a connector and a position identification on a multi-position connector.

19. The method of claim 16, wherein the wiring harness data includes connector data associated with at least some of the plurality of wires, and further comprising the steps of providing wire-connector assembly instructions

20. The method of claim 19, wherein the wire-connector assembly instructions contain instructions executable by an automated connector assembly machine.

21. The method of claim 19, wherein the wiring data includes for each wire at least one of a connector identification, a connector additional part identification, a connector additional plug identification and a connector seal identification.

22. The method of claim 19, further comprising the step of optimizing the wire groupings so as to minimize setup time between changeovers in the wire cutting and wire-connector assembly instructions.

23. The method of claim 22, wherein the optimization of the wire groupings is based on criteria associated with an assembling penalty value.

24. The method of claim 23, wherein the penalty value represents lost time during the changing of a given machine setup to another during the manufacture of the wiring harness.

25. The method of claim 23, wherein the criteria include:
a first and second criteria related to the presence of a first and a second sealant;
a third and fourth criteria related to the presence of first and second connection terminals; and
a fifth and sixth criteria related to the type of wire and the length of wire.

26. The method of claim 25, wherein the first to sixth criteria have decreasing respective penalty values.

27. The method of claim 19, further comprising providing at least one of a bill of material, an assembly list, a quality control check list, a quality control test procedure and a quality control default opportunity analysis.

28. The method of claim 19, further comprising the step of providing a wiring harness assembly drawing illustrating the wiring harness layout.

29. The method of claim 28, wherein the drawing is full-scale.

30. The method of claim 19, wherein the wiring data includes respective first lengths of the plurality of wires, the method further comprising:
providing a drawing of the wiring harness layout;
inferring respective second lengths of the plurality of wires from the drawing;
comparing the respective first lengths and the respective second lengths of the wires; and
identifying a wire length discrepancy between the respective first lengths and the respective second lengths of the wires.

31. The method of claim 30, further comprising providing a corrected wire length when a wire length discrepancy has been identified.

32. The method of claim 19, further comprising the step of providing a test program adapted to validate that each wire in the wiring harness is routed in accordance with the wiring data by sending a signal in the plurality of wires.

33. The method of claim 16, further comprising the steps of:
comparing the acquired wiring harness data with existing wiring harness data; and
identifying a corresponding existing wiring harness;
wherein the step of grouping the wires is further based on the wire grouping of the identified corresponding existing wiring harness.

34. A system for providing instructions for the manufacture of a wiring harness, comprising:
an input for acquiring data about the wiring harness to be manufactured, the wiring harness data including data about a plurality of wires to be assembled into the wiring harness;
a processing unit operatively connected to the input, the processing unit being configured so as to group the wires based on their data; and
an output operatively connected to the processing unit, the output being adapted to provide wire cutting instructions based on the grouping of the wires.

35. The system of claim 34, wherein the wiring data includes for each wire at least one of the wire number, a gage of the wire, an exterior color of the wire, a type of the wire, a length of the wire, a virtual address of the end of the wire, a break point at which the wire exists out of the wiring harness, a connector to be connected to the end of the wire, an identification of a seal that seals the wire to a connector and a position identification on a multi-position connector.

36. The system of claim 34, wherein the wiring harness data includes connector data associated with at least some of the plurality of wires and wherein the output is further adapted to provide wire-connector assembly instructions.

37. The method of claim 36, wherein the wiring data includes for each wire at least one of a connector identification, a connector additional part identification, a connector additional plug identification and a connector seal identification.

38. The system of claim 34, wherein the processing unit is further configured so as to optimize the wire groupings so as to minimize setup time between changeovers in the wire cutting and wire-connector assembly instructions.

39. The system of claim 38, wherein the optimization of the wire groupings is based on criteria associated with an assembling penalty value.

40. The system of claim 39, wherein the penalty value represents lost time during the changing of a given machine setup to another during the manufacture of the wiring harness.

41. The system of claim 39, wherein the criteria include:
a first and second criteria related to the presence of a first and a second sealant;
a third and fourth criteria related to the presence of first and second connection terminals; and
a fifth and sixth criteria related to the type of wire and the length of wire.

42. The system of claim 41, wherein the first to sixth criteria have decreasing respective penalty values.

43. The system of claim 36, wherein the processing unit is further configured so as to provide, through the output, at least one of a bill of material, an assembly list, a quality control check list, a quality control test procedure and a quality control default opportunity analysis.

44. The system of claim 34, wherein the processing unit is further configured so as to provide, through the output, a wiring harness assembly drawing illustrating the wiring harness layout.

45. The system of claim 44, wherein the drawing is full-scale.

46. The system of claim 34, wherein the wiring data includes respective first lengths of the plurality of wires, the processing unit is further configured so as to:
provide, through the output, a drawing of the wiring harness layout;
infer respective second lengths of the plurality of wires from the drawing;
compare the respective first lengths and the respective second lengths of the wires; and
identify a wire length discrepancy between the respective first lengths and the respective second lengths of the wires.

47. The system of claim 46, wherein the processing unit is further configured so as to provide a corrected wire length when a wire length discrepancy has been identified.

48. The system of claim 34, wherein the processing unit is further configured so as to:
compare the acquired wiring harness data with existing wiring harness data; and
identify a corresponding existing wiring harness;
wherein the grouping the wires is further based on the wire grouping of the identified corresponding existing wiring harness.

49. A system for manufacturing a wiring harness, comprising:
an input for acquiring data about the wiring harness to be manufactured, the wiring harness data including data about a plurality of wires to be assembled into the wiring harness;
a processing unit operatively connected to the input, the processing unit being so configured so as to:
group the wires based on their data; and
provide wire cutting instructions based on the grouping of the wires;
a cutting machine operatively connected to the processing unit for cutting wires in accordance with the cutting instructions.

50. The system of claim 49, wherein the wiring data includes for each wire at least one of the wire number, a gage of the wire, an exterior color of the wire, a type of the wire, a length of the wire, a virtual address of the end of the wire, a break point at which the wire exists out of the wiring harness, a connector to be connected to the end of the wire, an identification of a seal that seals the wire to a connector and a position identification on a multi-position connector.

51. The system of claim 49, wherein the wiring harness data includes connector data associated with at least some of the plurality of wires and wherein the processing unit is further configured so as to providing wire-connector assembly instructions, the system further comprising a connector assembly machine operatively connected to the processing unit for assembling connectors onto associated wires in accordance with the connector assembly instructions.

52. The system of claim 51, wherein the wiring data includes for each wire at least one of a connector identification, a connector additional part identification, a connector additional plug identification and a connector seal identification.

53. The system of claim 51, wherein the processing unit is further configured so as to optimize the wire groupings so as to minimize setup time between changeovers in the wire cutting and wire-connector assembly instructions.

54. The system of claim 53, wherein the optimization of the wire groupings is based on criteria associated with an assembling penalty value.

55. The system of claim 54, wherein the penalty value represents lost time during the changing of a given machine setup to another during the manufacture of the wiring harness.

56. The system of claim 54, wherein the criteria include
a first and second criteria related to the presence of a first and a second sealant;
a third and fourth criteria related to the presence of first and second connection terminals; and
a fifth and sixth criteria related to the type of wire and the length of wire.

57. The system of claim 55, wherein the first to sixth criteria have decreasing respective penalty values.

58. The system of claim 51, wherein the processing unit is so configured so as to provide, though the output, at least one of a bill of material, an assembly list, a quality control check list, a quality control test procedure and a quality control default opportunity analysis.

59. The system of claim 51, wherein the processing unit is so configured so as to provide, though the output, a wiring harness assembly drawing illustrating the wiring harness layout.

60. The system of claim 59, wherein the drawing is full-scale.

61. The system of claim 51, wherein the wiring data includes respective first lengths of the plurality of wires, the processing unit being further configured so as to:
provide, though the output, a drawing of the wiring harness layout;
infer respective second lengths of the plurality of wires from the drawing;
compare the respective first lengths and the respective second lengths of the wires; and
identify a wire length discrepancy between the respective first lengths and the respective second lengths of the wires.

62. The system of claim 61, further comprising providing a corrected wire length when a wire length discrepancy has been identified.

63. The method of claim 51, wherein the processing unit is so configured so as to validate that each wire in the wiring harness is routed in accordance with the wiring data by sending a signal in the plurality of wires.

64. The system of claim 48, wherein the processing unit is further configured so as to:
compare the acquired wiring harness data with existing wiring harness data; and
identify a corresponding existing wiring harness;
wherein the grouping the wires is further based on the wire grouping of the identified corresponding existing wiring harness.
